(19) United States
(12) Patent Application Publication
(10) Pub. No.: US 2015/0070606 A1
(43) Pub. Date: Mar. 12, 2015

(54) Projected Capacitive Touchscreen and Manufacturing Method Thereof

(71) Applicant: Huawei Device Co., Ltd., Shenzhen (CN)

(72) Inventor: Hang Yin, Shanghai (CN)

(21) Appl. No.: 14/547,433

(22) Filed: Nov. 19, 2014

Related U.S. Application Data
(63) Continuation of application No. PCT/CN2013/078564, filed on Jul. 1, 2013.

(30) Foreign Application Priority Data
Jun. 29, 2012 (CN) 201210222817.4

(51) Int. Cl. G02F 1/1333; G06F 3/044

(52) U.S. Cl. CPC G02F 1/13338; G06F 3/044; G06F 2203/04103; G06F 2203/04106; G02F 2202/28
USPC 349/12; 29/825

(57) ABSTRACT

A projected capacitive touchscreen and a manufacturing method thereof are provided. In the embodiments of the present invention, sensing electrodes and a polarizer are overlaid to form a sensing assembly, so that a substrate used in the sensing assembly in the prior art is not required, and that the sensing electrodes do not need to be formed on a cover lens. Therefore, thickness of a projected capacitive touchscreen is reduced without increasing manufacturing costs because the cover lens can be manufactured according to an existing process. Further, high mechanical strength of the cover lens is ensured, thereby achieving a purpose of taking both the manufacturing costs and the mechanical strength of the cover lens into consideration after thickness of a projected capacitive touchscreen is reduced.

### CROSS-REFERENCE TO RELATED APPLICATIONS

This application is a continuation of International Application No. PCT/CN2013/078564, filed on Jul. 1, 2013, which claims priority to Chinese Patent Application No. 201210222817.4, filed on Jun. 29, 2012, both of which are hereby incorporated by reference in their entireties.

### TECHNICAL FIELD

The present invention relates to an input device for human-computer interaction, and in particular, to a projected capacitive touchscreen and a manufacturing method thereof.

### BACKGROUND

Touchscreens in the prior art are classified into a resistive type, a capacitive type, an infrared type, and the like. Due to advantages such as a fast response, high reliability, and high durability, capacitive touchscreens are widely applied to electronic products. Among the capacitive touchscreens, a projected capacitive touchscreen becomes a mainstream development trend of current display touch technologies because the projected capacitive touchscreen can implement multipoint and accurate coordinate sensing and has a simple structure.

FIG. 1A shows a structure of a projected capacitive touchscreen in the prior art, where the projected capacitive touchscreen includes the following from bottom to top: a liquid crystal display (LCD) 1, an upper polarizer 2, first direction sensing electrodes 3, a substrate 4, second direction sensing electrodes 5, a bonding layer 6, and a cover lens 7. The first direction sensing electrodes 3 and the second direction sensing electrodes 5 are indium tin oxide (ITO) conductive circuits that are formed on top and bottom surfaces of the substrate 4 and are along a specified direction. Furthermore, the first direction sensing electrodes 3 and the second direction sensing electrodes 5 are electrically disconnected. The first direction sensing electrodes 3, the substrate 4, and the second direction sensing electrodes 5 that are sequentially overlaid form a sensing assembly. The bonding layer 6 is configured to bond the cover lens 7 to the second direction sensing electrodes 5. The LCD device is formed of two pieces of glass with liquid crystal between them. Black blocks between the first direction sensing electrodes 3 are insulation structures.

FIG. 1B shows another structure of a projected capacitive touchscreen in the prior art, where functional layers that are the same as those in FIG. 1A are marked the same. Differences from the structure shown in FIG. 1A are as follows. The first direction sensing electrodes 3 and the second direction sensing electrodes 5 are sequentially overlaid on the top surface of the substrate 4; black blocks between the first direction sensing electrodes 3 and between the first direction sensing electrodes 3 and the second direction sensing electrodes 5 are insulation structures (relative to thickness of other functional layers, thickness of the insulation structures between the first direction sensing electrodes 3 and the second direction sensing electrodes 5 may be ignored); and an electromagnetic shield layer 8 is formed on the bottom surface of the substrate that is opposite to the top surface.

When a user touches the cover lens 7 with a finger, capacitance between the first direction sensing electrodes 3 and the second direction sensing electrodes 5 in the touch position changes, and an electrostatic current that flows from the human body to the ground also changes accordingly. By measuring, through a circuit, a change in a current strength, it can be determined that the touch exists, and coordinates of the touch position can be calculated.

Because the substrate, whose thickness is much larger than thickness of other functional layers, is used to form the projected capacitive touchscreen, overall thickness of the projected capacitive touchscreen is large, which reduces an optical penetration rate thereof and further affects a display effect of the LCD. To solve the problem, a solution of manufacturing the first direction sensing electrodes and the second direction sensing electrodes on the bottom surface of the cover lens is proposed in the prior art, so that the substrate 4 in the structures shown in FIG. 1A and FIG. 1B is not required, thereby reducing the thickness of the projected capacitive touchscreen.

However, in the prior art, when the cover lens is manufactured, it needs to be cut and then reinforced (to increase hardness of the cover lens). Therefore, if the ITO conductive circuits are formed on the surface of the cover lens before the cover lens is cut, the cover lens cannot be reinforced; if the ITO conductive circuits are formed on the surface of each cover lens after the cover lens is cut and reinforced, manufacturing costs are largely increased; and if a large lens is reinforced before the ITO conductive circuits are formed on the surface and is then cut into small lens, processing difficulty is increased due to high hardness of the large lens, and therefore mechanical strength of the finally formed cover lens with the ITO conductive circuits deteriorates.

### SUMMARY

Embodiments of the present invention provide a projected capacitive touchscreen and a manufacturing method thereof, which solve a problem that in the prior art, manufacturing costs and mechanical strength of a cover lens cannot be taken into consideration at the same time after thickness of a projected capacitive touchscreen is reduced.

To achieve the foregoing purpose, the embodiments of the present invention adopt the following technical solutions.

A projected capacitive touchscreen includes the following from bottom to top: an LCD device, a sensing assembly, a bonding layer, and a cover lens, where the sensing assembly is formed of an upper polarizer, first direction sensing electrodes, and second direction sensing electrodes that are overlaid; and at least one of the first direction sensing electrodes and the second direction sensing electrodes is disposed between the upper polarizer and the bonding layer.

A method for manufacturing a projected capacitive touchscreen includes manufacturing a sensing assembly, where the sensing assembly is formed of an upper polarizer, first direction sensing electrodes, and second direction sensing electrodes that are overlaid, and at least one of the first direction sensing electrodes and the second direction sensing electrodes is disposed on a first surface of the upper polarizer; mounting an LCD device to the sensing assembly with a second surface of the upper polarizer that is opposite to the first surface facing the LCD device; and mounting a cover lens to the sensing assembly through a bonding layer with the first surface of the upper polarizer facing the bonding layer.

According to the projected capacitive touchscreen and the manufacturing method thereof provided in the embodiments of the present invention, the sensing electrodes and the upper polarizer are overlaid to form the sensing assembly, so that the substrate used in the sensing assembly in the prior art is not required, and that the sensing electrodes do not need to be formed on the cover lens. Therefore, the thickness of the touchscreen is reduced without increasing the manufacturing costs because the cover lens can be manufactured according to an existing process. Further, high mechanical strength of the cover lens is ensured, thereby achieving the purpose of taking both the manufacturing costs and the mechanical strength of the cover lens into consideration after the thickness of the projected capacitive touchscreen is reduced.

### BRIEF DESCRIPTION OF THE DRAWINGS

To describe the technical solutions in the embodiments of the present invention or in the prior art more clearly, the following briefly introduces accompanying drawings required for describing the embodiments or the prior art. The accompanying drawings in the following description show merely some embodiments of the present invention, and a person of ordinary skill in the art may still derive other drawings according to these accompanying drawings without creative efforts.

FIG. 1A is a schematic structural diagram of a projected capacitive touchscreen in the prior art;

FIG. 1B is another schematic structural diagram of a projected capacitive touchscreen in the prior art;

FIG. 2 is a schematic structural diagram of a projected capacitive touchscreen according to an embodiment of the present invention;

FIG. 3 is another schematic structural diagram of a projected capacitive touchscreen according to an embodiment of the present invention;

FIG. 4 is a flowchart of a method for manufacturing a projected capacitive touchscreen according to an embodiment of the present invention;

FIG. 5 is a flowchart of a method for manufacturing a sensing assembly according to an embodiment of the present invention; and

FIG. 6 is a flowchart of another method for manufacturing a sensing assembly according to an embodiment of the present invention.

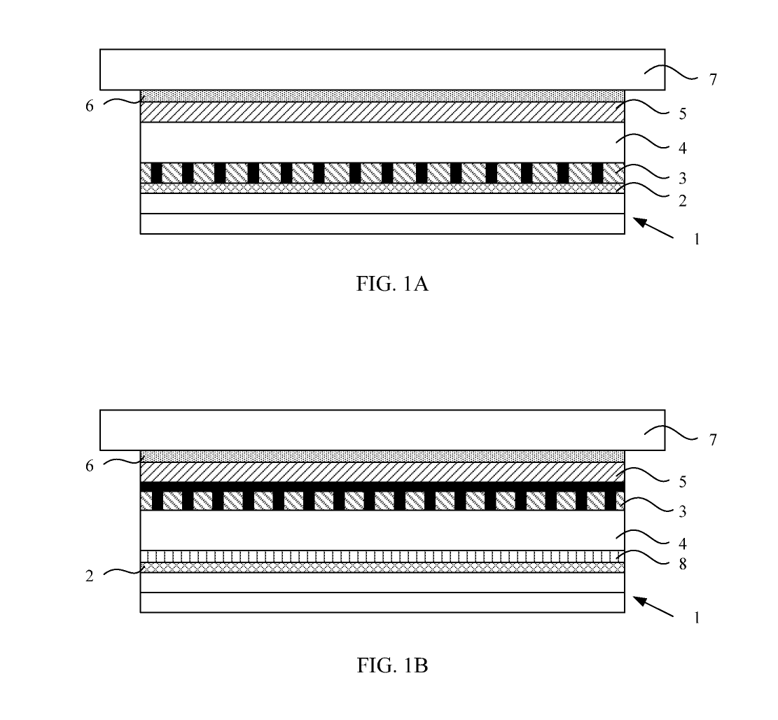

### DETAILED DESCRIPTION

The following clearly describes the technical solutions in the embodiments of the present invention with reference to the accompanying drawings in the embodiments of the present invention. The embodiments to be described are merely a part rather than all of the embodiments of the present invention. All other embodiments obtained by a person of ordinary skill in the art based on the embodiments of the present invention without creative efforts shall fall within the protection scope of the present invention.

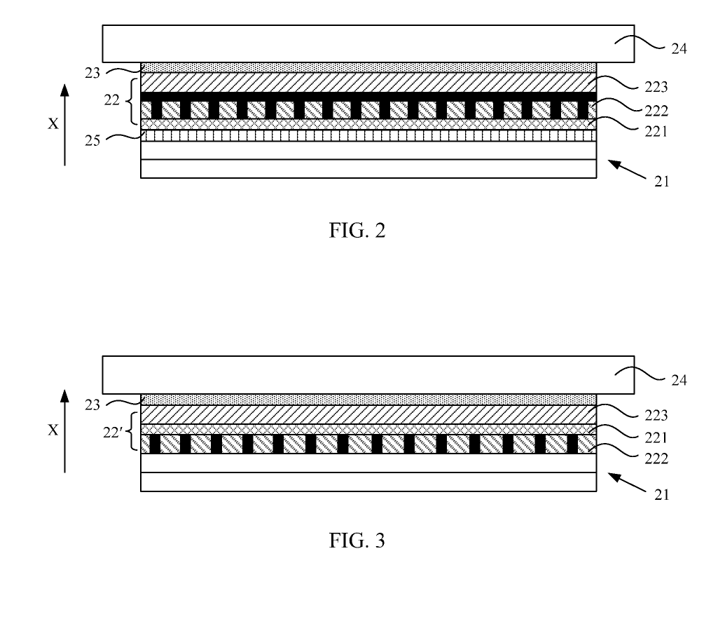

An embodiment of the present invention provides a projected capacitive touchscreen. As shown in FIG. 2, the projected capacitive touchscreen includes the following from bottom to top (in an X direction): an LCD device 21, a sensing assembly 22, a bonding layer 23, and a cover lens 24, where the sensing assembly 22 is formed of an upper polarizer 221, first direction sensing electrodes 222, and second direction sensing electrodes 223 that are overlaid, and at least one of the first direction sensing electrodes 222 and the second direction sensing electrodes 223 is disposed between the upper polarizer 221 and the bonding layer 23.

The foregoing “overlaid” means that according to a specified direction, a second layer is disposed on a first layer, a third layer is disposed on the second layer, and so on. However, it does not necessarily mean that overlaying is performed according to a sequence of the upper polarizer 221, the first direction sensing electrodes 222, and the second direction sensing electrodes 223 shown in FIG. 2. Instead, the overlaying may be performed in any sequence of the three layers. For example, the first direction sensing electrodes 222, the upper polarizer 221, and the second direction sensing electrodes 223 are sequentially overlaid from bottom to top. In FIG. 2, black blocks between the first direction sensing electrodes 222 and between the first direction sensing electrodes 222 and the second direction sensing electrodes 223 are insulation structures (relative to thickness of other layers, thickness of the insulation structure between the first direction sensing electrodes 222 and the second direction sensing electrodes 223 may be ignored).

Because it is specified that at least one of the first direction sensing electrodes and the second direction sensing electrodes is disposed between the upper polarizer and the bonding layer, sensing assemblies of two structures can be defined.

FIG. 2 shows a projected capacitive touchscreen of a first structure, where in the X direction from bottom to top, the sensing assembly 22 is formed of the upper polarizer 221, the first direction sensing electrodes 222, and the second direction sensing electrodes 223 that are sequentially overlaid.

FIG. 3 shows a projected capacitive touchscreen of a second structure, where in the X direction from bottom to top, a sensing assembly 22′ is formed of the first direction sensing electrodes 222, the upper polarizer 221, and the second direction sensing electrodes 223 that are sequentially overlaid, and black blocks between the first direction sensing electrodes 222 are insulation structures.

It should be noted that the structures in FIG. 3 that are the same as those in FIG. 2 are marked the same.

For the projected capacitive touchscreen of the first structure, an electromagnetic shield layer 25 may also be disposed between the upper polarizer 221 and the LCD device 21. In the structure shown in FIG. 2, both the first direction sensing electrodes 222 and the second direction sensing electrodes 223 are formed on a same side of the upper polarizer 221, the sensing electrodes are conductors, and the upper polarizer 221 is an insulator. Therefore, electromagnetic noise from a side of the LCD device 21 may cause an adverse impact on the sensing assembly 22. The electromagnetic shield layer 25 that is disposed on another side of the upper polarizer 221 without sensing electrodes can prevent the adverse impact of the electromagnetic noise on the sensing assembly 22.

In the projected capacitive touchscreen of the second structure, the first direction sensing electrodes may be distributed in a large area under the upper polarizer, that is, a circuit width may be large, but an interval may be small, so that the first direction sensing electrodes can be seen as an electromagnetic shield layer. In addition, generally, the first direction sensing electrodes bear a drive signal, the second direction sensing electrodes bear a receive signal, and the drive signal is not subject to interference. Therefore, the first direction sensing electrodes can be shared as an electromagnetic shield layer.

In the projected capacitive touchscreen provided in this embodiment of the present invention, the sensing electrodes and the upper polarizer are overlaid to form the sensing assembly, so that the substrate used in the sensing assembly in the prior art is not required, and that the sensing electrodes do not need to be formed on the cover lens. Therefore, the thickness of the touchscreen is reduced without increasing the manufacturing costs because the cover lens can be manufactured according to an existing process. Further, high mechanical strength of the cover lens is ensured, thereby achieving the purpose of taking both the manufacturing costs and the mechanical strength of the cover lens into consideration after the thickness of the projected capacitive touchscreen is reduced.

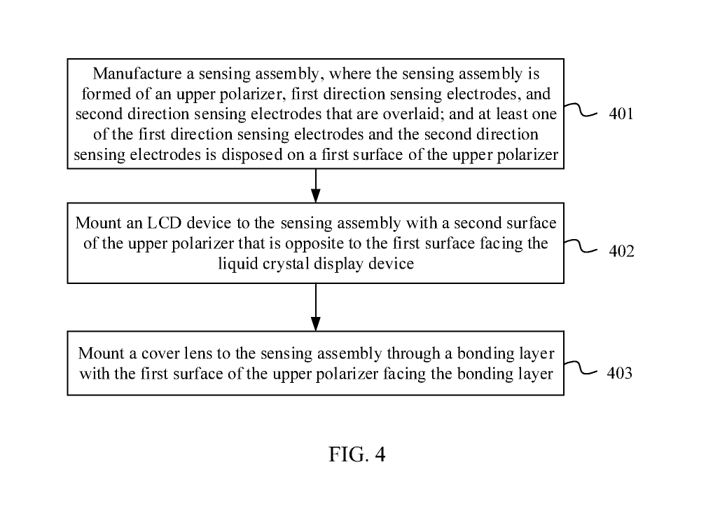

An embodiment of the present invention further provides a method for manufacturing a projected capacitive touchscreen. As shown in FIG. 4, the method includes the following steps.

401. Manufacture a sensing assembly, where the sensing assembly is formed of an upper polarizer, first direction sensing electrodes, and second direction sensing electrodes that are overlaid; and at least one of the first direction sensing electrodes and the second direction sensing electrodes is disposed on a first surface of the upper polarizer.

402. Mount an LCD device to the sensing assembly with a second surface of the upper polarizer facing the LCD device, where the second surface is opposite to the first surface.

403. Mount a cover lens to the sensing assembly through a bonding layer with the first surface of the upper polarizer facing the bonding layer.

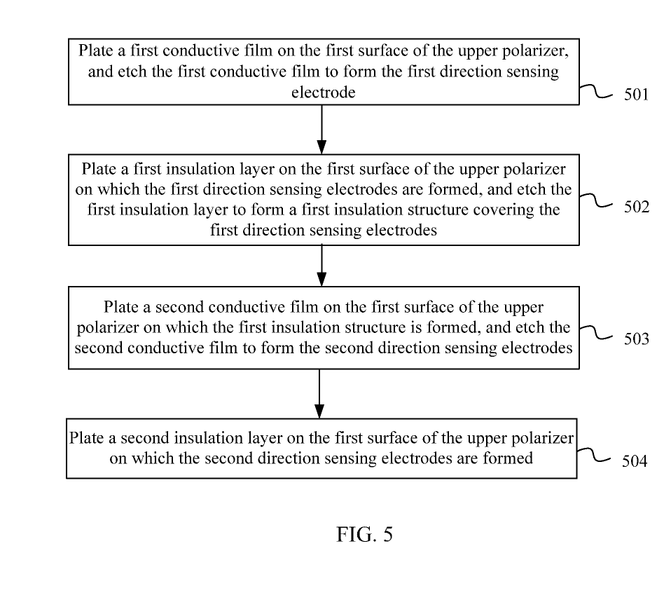

In the foregoing method, two specific methods for manufacturing the sensing assembly may exist. A first method, as shown in FIG. 5, includes the following steps.

501. Plate a first conductive film on the first surface of the upper polarizer, and etch the first conductive film to form the first direction sensing electrodes.

502. Plate a first insulation layer on the first surface of the upper polarizer on which the first direction sensing electrodes are formed, and etch the first insulation layer to form a first insulation structure covering the first direction sensing electrodes.

503. Plate a second conductive film on the first surface of the upper polarizer on which the first insulation structure is formed, and etch the second conductive film to form the second direction sensing electrodes.

504. Plate a second insulation layer on the first surface of the upper polarizer on which the second direction sensing electrodes are formed.

The first insulation layer is used to ensure electrical disconnection between the second direction sensing electrodes and the first direction sensing electrodes and between the first direction sensing electrodes; and the second insulation layer is used to ensure electrical disconnection between the second direction sensing electrodes.

In the sensing assembly obtained by using the method for manufacturing the sensing assembly, the sensing electrodes are formed on a same side of the upper polarizer, the sensing electrodes are conductors, and the upper polarizer is an insulator. To prevent electromagnetic noise that comes from a side of the LCD device from causing an adverse impact on the sensing assembly, in the method for manufacturing a projected capacitive touchscreen, before the step of mounting the LCD device to the sensing assembly, the method may further include plating a third conductive film on the second surface of the upper polarizer to form an electromagnetic shield layer. By using the methods shown in FIG. 4 and FIG. 5 and the method for forming the electromagnetic shield layer, the projected capacitive touchscreen shown in FIG. 2 can be obtained. In step 402, the LCD device can be mounted to the sensing assembly by using bonding glue on the second surface of the upper polarizer.

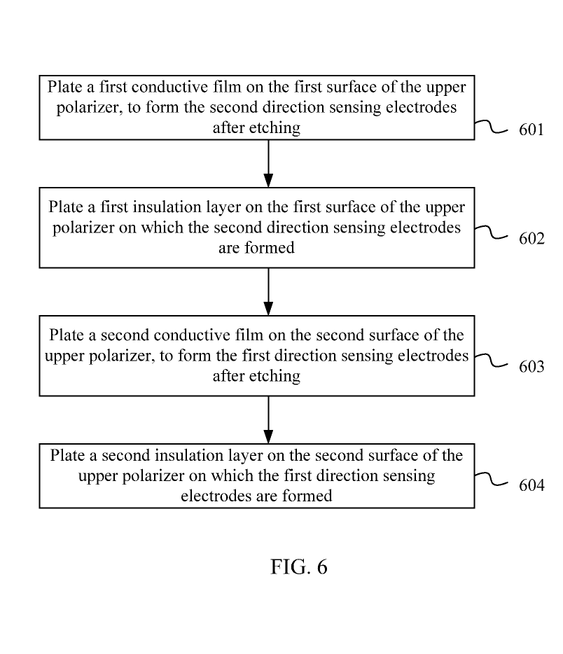

A second method, as shown in FIG. 6, includes the following steps.

601. Plate a first conductive film on the first surface of the upper polarizer to form the second direction sensing electrodes after etching.

602. Plate a first insulation layer on the first surface of the upper polarizer on which the second direction sensing electrodes are formed.

The first insulation layer is used to ensure electrical disconnection between the second direction sensing electrodes.

603. Plate a second conductive film on the second surface of the upper polarizer to form the first direction sensing electrodes after etching.

604. Plate a second insulation layer on the second surface of the upper polarizer on which the first direction sensing electrodes are formed.

The second insulation layer is used to ensure electrical disconnection between the first direction sensing electrodes.

By using the methods shown in FIG. 4 and FIG. 6, the projected capacitive touchscreen shown in FIG. 3 can be obtained.

In the projected capacitive touchscreen obtained by using the method for manufacturing a projected capacitive touchscreen according to the embodiment of the present invention, the sensing electrodes and the polarizer are overlaid to form the sensing assembly, so that the substrate used in the sensing assembly in the prior art is not required, and that the sensing electrodes do not need to be formed on the cover lens. Therefore, the thickness of the touchscreen is reduced without increasing the manufacturing costs because the cover lens can be manufactured according to an existing process. Further, high mechanical strength of the cover lens is ensured, thereby achieving the purpose of taking both the manufacturing costs and the mechanical strength of the cover lens into consideration after the thickness of the projected capacitive touchscreen is reduced.

It should be noted that in the foregoing embodiments, the conductive film may be an indium tin oxide film; and an extension direction of the first direction sensing electrodes is different from an extension direction of the second direction sensing electrodes, and generally, an angle between a first direction and a second direction is 90 degrees, and the angle may also be designed to another degree according to a performance requirement. In the foregoing embodiments, the first direction sensing electrodes are disposed under the second direction sensing electrodes. Certainly, the present invention is not limited thereto, and the second direction sensing electrodes may also be disposed under the first direction sensing electrodes, so that the sensing assembly is formed of the upper polarizer, the second direction sensing electrodes, and the first direction sensing electrodes that are sequentially overlaid from bottom to top, or that the sensing assembly is formed of the second direction sensing electrodes, the upper polarizer, and the first direction sensing electrodes that are sequentially overlaid from bottom to top.

The embodiments of the present invention are mainly applied to a device that requires both a display and a touchscreen, for example, a mobile phone, a phone display, a tablet computer, a computer display, a television, or a household appliance.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A projected capacitive touchscreen, comprising:
a liquid crystal display device;
a sensing assembly;
a bonding layer; and
a cover lens,
wherein in a direction from a bottom of the projected capacitive touchscreen to a top of the projected capacitive touchscreen, the projected capacitive touchscreen comprises the liquid crystal display device, the sensing assembly, the bonding layer, and the cover lens,
wherein the sensing assembly is formed of an upper polarizer, first direction sensing electrodes, and second direction sensing electrodes that are overlaid, and
wherein at least one of the first direction sensing electrodes and the second direction sensing electrodes is disposed between the upper polarizer and the bonding layer.

2. The projected capacitive touchscreen according to claim 1, wherein in the direction from the bottom of the projected capacitive touchscreen to the top of the projected capacitive touchscreen, the sensing assembly is formed of the upper polarizer, the first direction sensing electrodes, and the second direction sensing electrodes that are sequentially overlaid.

3. The projected capacitive touchscreen according to claim 2, wherein an electromagnetic shield layer is further comprised between the upper polarizer and the liquid crystal display device.

4. The projected capacitive touchscreen according to claim 1, wherein in the direction from the bottom of the projected capacitive touchscreen to the top of the projected capacitive touchscreen, the sensing assembly is formed of the first direction sensing electrodes, the upper polarizer, and the second direction sensing electrodes that are sequentially overlaid.

5. A method for manufacturing a projected capacitive touchscreen, comprising:
manufacturing a sensing assembly, wherein the sensing assembly is formed of an upper polarizer, first direction sensing electrodes, and second direction sensing electrodes that are overlaid, and wherein at least one of the first direction sensing electrodes and the second direction sensing electrodes is disposed on a first surface of the upper polarizer;
mounting a liquid crystal display device to the sensing assembly with a second surface of the upper polarizer facing the liquid crystal display device, where the second face is opposite to the first surface; and
mounting a cover lens to the sensing assembly through a bonding layer with the first surface of the upper polarizer facing the bonding layer.

6. The method according to claim 5, wherein the method for manufacturing the sensing assembly comprises:
plating a first conductive film on the first surface of the upper polarizer;
etching the first conductive film to form the first direction sensing electrodes;
plating a first insulation layer on the first surface of the upper polarizer on which the first direction sensing electrodes are formed;
etching the first insulation layer to form a first insulation structure covering the first direction sensing electrodes;
plating a second conductive film on the first surface of the upper polarizer on which the first insulation structure is formed;
etching the second conductive film to form the second direction sensing electrodes; and
plating a second insulation layer on the first surface of the upper polarizer on which the second direction sensing electrodes are formed.

7. The method according to claim 6, wherein before mounting the liquid crystal display device to the sensing assembly, the method further comprises plating a third conductive film on the second surface of the upper polarizer to form an electromagnetic shield layer.

8. The method according to claim 5, wherein the method for manufacturing the sensing assembly comprises:
plating a first conductive film on the first surface of the upper polarizer to form the second direction sensing electrodes after etching;
plating a first insulation layer on the first surface of the upper polarizer on which the second direction sensing electrodes are formed;
plating a second conductive film on the second surface of the upper polarizer to form the first direction sensing electrodes after etching; and
plating a second insulation layer on the second surface of the upper polarizer on which the first direction sensing electrodes are formed.
